(19) United States
(12) Patent Application Publication
(10) Pub. No.: US 2007/0030790 A1
(43) Pub. Date: Feb. 8, 2007

(54) Information carrier and system for reading data stored on such an information carrier

(75) Inventors: Robert Frans Maria Hendriks, Eindhoven (NL); Thomas Jan De Hoog, Eindhoven (NL); Coen Theodorus Hubertus Fransiscu Liedenbaum, Eindhoven (NL); Mohammed Meftah, Eindhoven (NL); Henricus Renatus Martinus Verberne, Eindhoven (NL); Arjen Gerben Sijde, Eindhoven (NL); Aloysius Franciscus Maria Sander, Eindhoven (NL); Aukje Arianne Annette Kastelijn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/571,820

(22) PCT Filed: Sep. 2, 2004
(86) PCT No.: PCT/IB04/02886

§ 371 Date: Mar. 15, 2006

(30) Foreign Application Priority Data
Sep. 18, 2003 (EP) 03300122.3
Dec. 16, 2003 (EP) 03300268.4
May 26, 2004 (EP) 04300304.5
Jun. 22, 2004 (EP) 04300389.6

(51) Int. Cl. G11B 7/00

(52) U.S. Cl. 369/120

(57) ABSTRACT

The invention relates to a system for reading data stored on an information carrier (201), said system comprising: an optical element (202) for generating an array of light spots (203) from an input light beam (204), said array of light spots (203) being intended to scan said information carrier (201), a detector (205) for detecting said data from an array of output light beams generated by said information carrier (201) in response of said array of light spots (203). Use: Optical storage

### FIELD OF THE INVENTION

The invention relates to a system for reading data stored on an information carrier.

The invention also relates to a reading apparatus comprising such a system.

The invention also relates to an information carrier intended to be read by such system and reading apparatus.

The invention may be used in the field of optical data storage.

### BACKGROUND OF THE INVENTION

Use optical storage is nowadays widespread for content distribution, for example in storage systems based on the DVD (Digital Versatile Disk) standards. Optical storage has a big advantage over hard-disk and solid-state storage in that information carriers are easy and cheap to duplicate.

However, due to the large amount of moving parts in the drives, known applications using this type of storage are not robust to shocks when performing read operations, considering the required stability of said moving parts during such operations. As a consequence, optical storage cannot easily be used in applications which are subject to shocks, such as in portable devices.

### OBJECT AND SUMMARY OF THE INVENTION

It is an object of the invention to propose a new system for reading data stored on an information carrier.

To this end, the system according to the invention for reading data stored on an information carrier comprises:
an optical element for generating an array of light spots from an input light beam, said array of light spots being intended to scan said information carrier,
a detector for detecting said data from an array of output light beams generated by said information carrier in response of said array of light spots.

This system includes a static information carrier (also called optical card) intended to store binary data organized in a data matrix. The bits on the information carrier are for example represented by transparent and non-transparent areas. Alternatively, the data are coded according to a multilevel approach.

The information carrier is intended to be illuminated not by a single light beam, but by an array of light spots generated by the optical element. The optical element corresponds advantageously to an array of micro-lenses, or to an array of apertures designed to exploit the Talbot effect.

Each light spot selects a specific area of data to be read on the information carrier, said data being detected by the detector. By moving the optical element over the information carrier, the light spots can scan the entire information carrier.

Since the information carrier is static (i.e. motionless), the number of moving elements is highly reduced so that the system leads to a robust mechanical solution.

The system allows to use an information carrier which combines the advantages of solid-state storage in that it is static, and the advantages of optical storage in that it is removable from the reader apparatus which comprises the system.

In an embodiment, one pixel of the detector is intended to detect one data of the information carrier. In a preferred embodiment, one pixel of the detector is intended to detect a set of data, each data from this set of data being read successively by a single light spot. This allows to circumvent the fact that pixels of the detector have a limited size, and to increase the storage capacity in a cost-effective manner.

In a preferred embodiment, the system according to the invention comprises an optical fiber plate (FP) stacked on said detector for carrying said output light beams.

The advantage of using an optical fiber plate instead of an array of lenses is that cross-talk between two consecutive output light beams is highly reduced, while the high numerical aperture of the fibers ensures a large light collection efficiency. Data reading on the information carrier is thus improved.

It is also an object of the invention to propose a reading apparatus for reading data stored on an information carrier, said reading apparatus comprising a system according to the invention.

It is also an object of the invention to propose an information carrier comprising an array of data arranged in macro-cells, each macro-cell data being intended to be read by a single light spot in the reading system according to the invention. The data are either represented by transparent and non-transparent areas, by reflective and non-reflective areas, or advantageously represented in using a multilevel scheme in order to increase the storage capacity of the information carrier.

According to a preferred embodiment, the information carrier is made of adjacent elementary data areas having an hexagonal shape.

According to a preferred embodiment, the elementary data areas are grouped so as to form an hexagonal lattice.

First, this allows to increase the data density of the information carrier. Secondly, since data density is increased, the scanning distance between consecutive elementary data area is reduced, which implies an easier scanning mechanism. Finally, the distance between the light spots may be increased, which results in a more robust bit detection since crosstalk between adjacent elementary data area is reduced.

The invention also relates to various reading apparatus implementing such a reading system.

Detailed explanations and other aspects of the invention will be given below.

### BRIEF DESCRIPTION OF THE DRAWINGS

The particular aspects of the invention will now be explained with reference to the embodiments described hereinafter and considered in connection with the accompanying drawings, in which identical parts or sub-steps are designated in the same manner:

FIG. 1 depicts a first system according to the invention,

FIG. 2 depicts a second system according to the invention,

FIG. 3 depicts a detailed view of components dedicated to macro-cell scanning used in systems according to the invention,

FIG. 4 illustrates the principle of macro-cell scanning according to the invention,

FIG. 5 depicts an information carrier according to the invention,

FIG. 6A to FIG. 6C depict different types of elementary data areas in an information carrier according to the invention,

FIG. 7 depicts a three-dimensional view of the second system according to the invention,

FIG. 8 depicts a first arrangement for moving the systems according to the invention over an information carrier,

FIG. 9 depicts a second arrangement for moving the systems according to the invention over an information carrier,

FIG. 10 depicts detailed elements of the second arrangement for moving the systems according to the invention over an information carrier,

FIG. 11 depicts a third system according to the invention,

FIG. 12 depicts a detailed view of the third system according to the invention,

FIG. 13 depicts a three-dimensional view of the third system according to the invention,

FIGS. 14A and 14B illustrate elementary data areas having square and hexagonal shapes,

FIG. 15 depicts an improved information carrier according to the invention where the macro-cells form a square lattice,

FIG. 16 depicts an improved information carrier according to the invention where the macro-cells form an hexagonal lattice,

FIG. 17 illustrates various apparatus and devices comprising a system for reading an information carrier according to the invention.

### DETAILED DESCRIPTION OF THE INVENTION

The system according to the invention aims at reading data stored on an information carrier. The information carrier is intended to store binary data organized according to an array, as in a data matrix. If the information carrier is intended to be read in transmission, the states of binary data stored on the information carrier are represented by transparent areas and non-transparent areas (i.e. light-absorbing). Alternatively, if the information carrier is intended to be read in reflection, the states of binary data stored on the information carrier are represented by non-reflective areas (i.e. light-absorbing) and reflective areas. The areas are marked in a material such as glass, plastic or a material having magnetic properties.

The system according to the invention comprises:

an optical element for generating an array of light spots from an input light beam, said array of light spots being intended to scan said information carrier,
a detector for detecting said data from an array of output light beams generated by said information carrier.

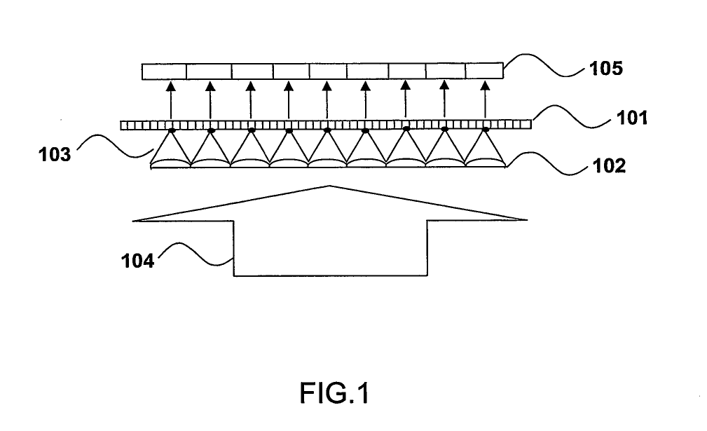

In a first embodiment depicted in FIG. 1, the system according to the invention for reading data stored on an information carrier 101 comprises an optical element 102 for generating an array of light spots 103 from an input light beam 104, said array of light spots 103 being intended to scan the information carrier 101.

The optical element 102 corresponds to a two-dimensional array of micro-lenses to the input of which the coherent input light beam 104 is applied. The array of micro-lenses 102 is placed parallel and distant from the information carrier 101 so that light spots are focussed on the information carrier. The numerical aperture and quality of the micro-lenses determines the size of the light spots. For example, a two-dimensional array of micro-lenses 102 having a numerical aperture which equals 0.3 can be used. The input light beam 104 can be realized by a waveguide (not represented) for expanding an input laser beam, or by a two-dimensional array of coupled micro lasers.

The light spots are applied on transparent or non-transparent areas of the information carrier 101. If a light spot is applied on a non-transparent area, no output light beam is generated in response by the information carrier. If a light spot is applied on a transparent area, an output light beam is generated in response by the information carrier, said output light beam being detected by the detector 105. The detector 105 is thus used for detecting the binary value of the data of the area to which the optical spot is applied.

The detector 105 is advantageously made of an array of CMOS or CCD pixels. For example, one pixel of the detector is placed opposite an elementary data area containing one data (i.e. one bit) of the information carrier. In that case, one pixel of the detector is intended to detect one data of the information carrier.

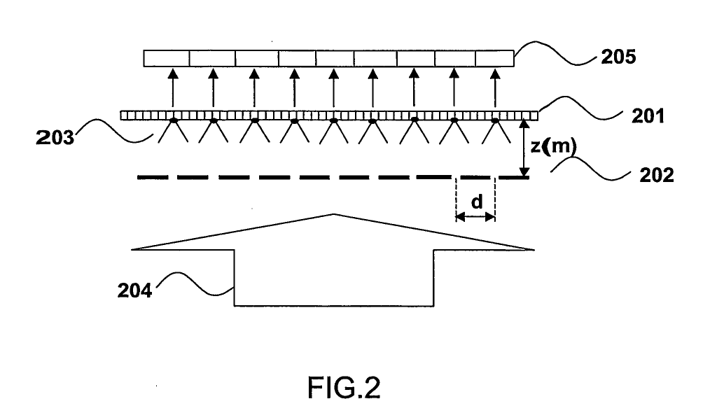

In a second embodiment depicted in FIG. 2, the system according to the invention for reading data stored on an information carrier 201 comprises an optical element 202 for generating an array of light spots 203 from an input light beam 204, said array of light spots 203 being intended to scan the information carrier 201.

The optical element 202 corresponds to a two-dimensional array of apertures to the input of which the coherent input light beam 204 is applied. The apertures correspond for example to circular holes having a diameter of 1 μm or much smaller. The input light beam 204 can be realized by a waveguide (not represented) for expanding an input laser beam, or by a two-dimensional array of coupled micro lasers.

The light spots are applied to transparent or non-transparent areas of the information carrier 201. If a light spot is applied to a non-transparent area, no output light beam is generated in response by the information carrier. If a light spot is applied to a transparent area, an output light beam is generated in response by the information carrier, said output light beam being detected by the detector 205. Similarly as the first embodiment depicted in FIG. 1, the detector 205 is thus used for detecting the binary value of the data of the area on which the optical spot is applied.

The detector 205 is advantageously made of an array of CMOS or CCD pixels. For example, one pixel of the detector is placed opposite an elementary data area containing a data of the information carrier. In that case, one pixel of the detector is intended to detect one data of the information carrier.

The array of light spots 203 is generated by the array of apertures 202 in exploiting the Talbot effect which is a diffraction phenomenon working as follows. When a coherent light beams, such as the input light beam 204, is applied to an object having a periodic diffractive structure (thus forming light emitters), such as the array of apertures 202, the diffracted lights recombine into identical images of the emitters at a plane located at a predictable distance z0 from the diffracting structure. This distance z0 is known as the Talbot distance. The Talbot distance z0 is given by the relation z0=2.n.d²/λ, where d is the periodic spacing of the light emitters, λ is the wavelength of the input light beam, and n is the refractive index of the propagation space. More generally, re-imaging takes place at other distances z(m) spaced further from the emitters and which are a multiple of the Talbot distance z such that z(m)=2.n.m.d²/λ, where m is an integer. Such a re-imaging also takes place for m=½+an integer, but here the image is shifted over half a period. The re-imaging also takes place for m=¼+an integer, and for m=¾+an integer, but the image has a doubled frequency which means that the period of the light spots is halved with respect to that of the array of apertures.

Exploiting the Talbot effect allows to generate an array of light spots of high quality at a relatively large distance from the array of apertures 202 (a few hundreds of μm, expressed by z(m)), without the need for optical lenses. This allows to insert for example a cover layer between the array of aperture 202 and the information carrier 201 to prevent the latter from contamination (e.g. dust, finger prints . . . ). Moreover, this facilitates the implementation and allows to increase in a cost-effective manner, compared to the use of an array of micro-lenses, the density of light spots which are applied to the information carrier.

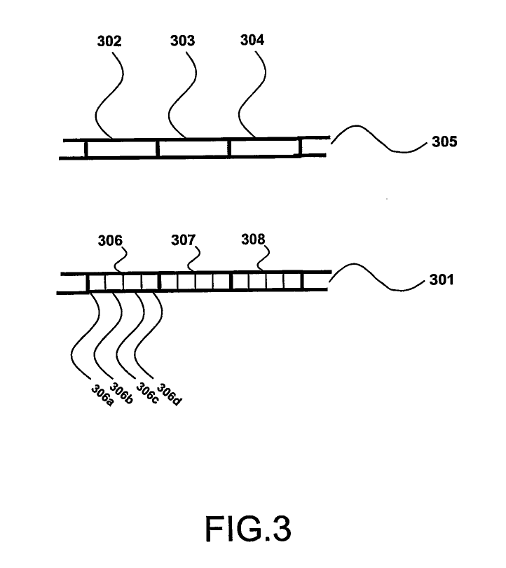

FIG. 3 depicts a detailed view of the system according to the invention. It depicts a detector 305 which is intended to detect data from output light beams generated by the information carrier 301. The detector comprises pixels referred to as 302-303-304, the number of pixels shown being limited to facilitate the understanding. In particular, pixel 302 is intended to detect data stored on the data area 306 of the information carrier, pixel 303 is intended to detect data stored on the data area 307, and pixel 304 is intended to detect data stored on the data area 308. Each data area (also called macro-cell) comprises a set of elementary data. For example, data area 306 comprises binary data referred to as 306a-306b-306c-306d.

In this embodiment, one pixel of the detector is intended to detect a set of data, each elementary data among this set of data being successively read by a single light spot generated either by the array of micro-lenses 102 depicted in FIG. 1, or by the array of apertures depicted in FIG. 2. This way of reading data on the information carrier is called macro-cell scanning in the following.

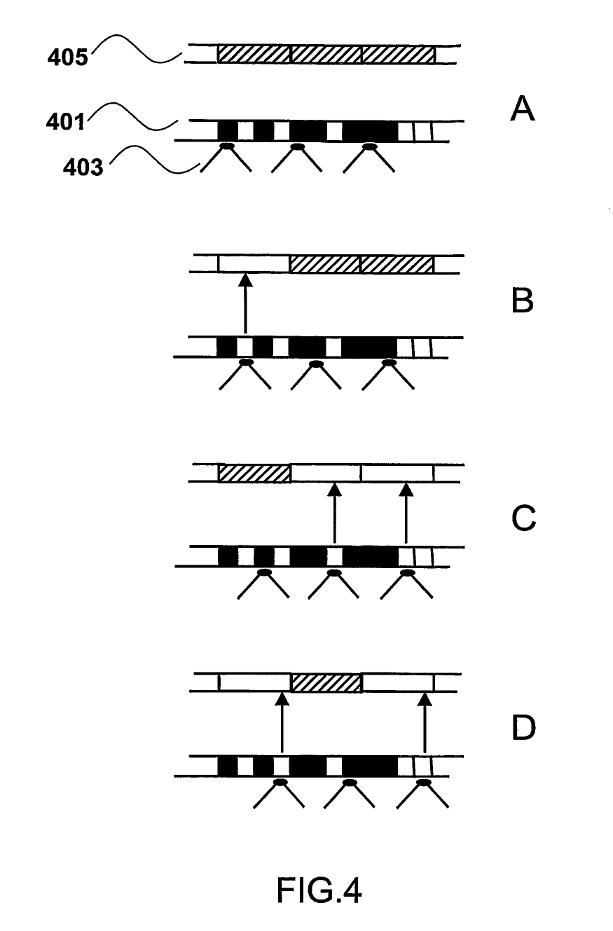

FIG. 4, which is based on FIG. 3, illustrates by a non-limitative example the macro-cell scanning of an information carrier 401.

Data stored on the information carrier 401 have two states indicated either by a black area (i.e. non-transparent) or white area (i.e. transparent). For example, a black area corresponds to a “0” binary state while a white area corresponds to a “1” binary state.

When a pixel of the detector 405 is illuminated by an output light beam generated by the information carrier 401, the pixel is represented by a white area. In that case, the pixel delivers an electric output signal (not represented) having a first state. On the contrary, when a pixel of the detector 405 does not receive any output light beam from the information carrier, the pixel is represented by a cross-hatched area. In that case, the pixel delivers an electric output signal (not represented) having a second state.

In this example, each set of data comprises four elementary data, and a single light spot is applied simultaneously to each set of data. The scanning of the information carrier 401 by the light spots 403 is performed for example from left to right, with an incremental lateral displacement which equals the distance between two elementary data.

In position A, all the light spots are applied to non-transparent areas so that all pixels of the detector are in the second state.

In position B, after displacement of the light spots to the right, the light spot to the left is applied to a transparent area so that the corresponding pixel is in the first state, while the two other light spots are applied to non-transparent areas so that the two corresponding pixels of the detector are in the second state.

In position C, after displacement of the light spots to the right, the light spot to the left is applied to a non-transparent area so that the corresponding pixel is in the second state, while the two other light spots are applied to transparent areas so that the two corresponding pixels of the detector are in the first state.

In position D, after displacement of the light spots to the right, the central light spot is applied to a non-transparent area so that the corresponding pixel is in the second state, while the two other light spots are applied to transparent areas so that the two corresponding pixels of the detector are in the first state.

The scanning of the information carrier 401 is complete when the light spots have been applied to all data of a set of data facing a pixel of the detector. It implies a two-dimensional scanning of the information carrier. Elementary data which compose a set of data opposite a pixel of the detector are read successively by a single light spot.

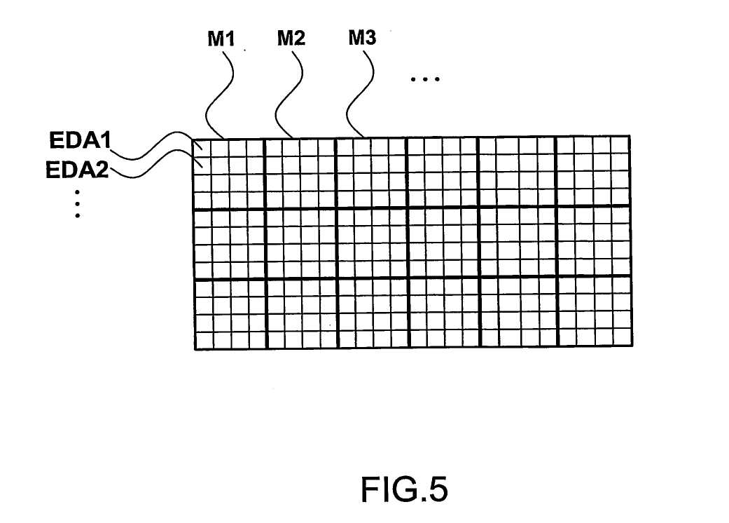

FIG. 5 represents a top view of an information carrier according to the invention. This information carrier comprises a plurality of adjacent macro-cells (M1, M2, M3, . . . ), each macro-cell comprising a set of elementary data areas (EDA1, EDA2, . . . ). In this example, each macro-cell comprises 16 elementary data areas. To facilitates the scanning of a macro-cell, the elementary data areas are advantageously are placed adjacent and arranged according to a matrix, and have a square shape.

Each macro-cell is intended to be read by a single light spot, in scanning successively said single light spot over all elementary data areas of said macro-cell. The width of the light spot intended to be applied on each macro-cell is advantageously equal to the width of the elementary data areas, so that a maximum of light intensity is detected by the pixels of the detector.

According to a simple solution, each elementary data area is intended to store one binary data. To this end, each elementary data may be represented by a transparent (i.e. light non-absorbing) and non-transparent areas (i.e. light absorbing), or alternatively by reflective and non-reflective areas.

Alternatively, the data may be coded according to a multilevel scheme in order to increase the data density of the information carrier. To this end, instead of defining each elementary data area by only two levels of light propagation, it is proposed to define each elementary data area by N levels, where N might advantageously be a power of 2. In this case, it is assumed that ²log(N) bits (²log being the binary logarithm operator) can be coded per elementary data area. For example, if N=4, it becomes possible to store a 2-bits data in each elementary data area, thus doubling the storage capacity on the information carrier.

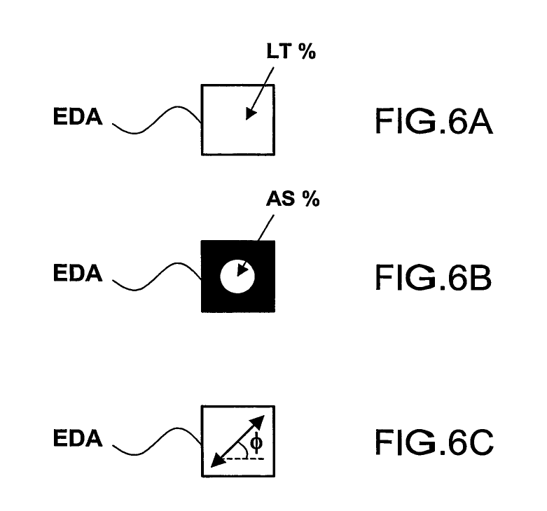

FIG. 6A illustrates a first solution of a two-levels data coding in an elementary data area EDA (N=4 in this case). The elementary data area comprises a layer made of a material characterized by a light-transmission percentage LT. The percentage LT is taken among a set of 4 values, depending on the value of the 2-bits data to be coded For example:
a first value of LT=5% may be used to encode a 2-bits data which value is 00,
a second value of LT=35% may be used to encode a 2-bits data which value is 01,
a third value of LT=65% may be used to encode a 2-bits data which value is 10,
a fourth value of LT=95% may be used to encode a 2-bits data which value is 11,
   As a consequence, a light spot which passes through an elementary data area is converted by a detector pixel into an electrical signal which may take 4 different levels. By the use of three thresholds (or N−1 thresholds generally speaking) applied to this electrical signal, the 2-bits data can easily be recovered.

It is noted that the percentage LT can be defined in changing the light-transmission coefficient of the material (4 different coefficients are thus potentially defined), or alternatively in changing the thickness of the elementary data area while using a material having a given light-transmission coefficient (4 different thicknesses are thus potentially defined).

The layer may be made of a dye material as that used in CD-R and DVD-R disks. Alternatively, the layer may be made of a metal layers (e.g. chromium or aluminium) whose thickness is varied for defining a variable light-transmitting layer.

FIG. 6B depicts a second solution of a two-levels data coding in an elementary data area EDA (N=4 in this case). The elementary data area comprises a layer made of a non-transparent material (i.e. light absorbing). Two cases have to be considered.

First, if the information carrier is used in a transmission mode, the elementary data area also comprises an aperture letting the light spot pass through it

Secondly, if the information carrier is used in a reflection mode, the elementary data area also comprises a reflecting surface so that the light spot is partially reflected.

The aperture (or alternatively the reflecting surface) may be expressed as a percentage AS of the total surface of the elementary data area EDA. The percentage AS is taken among a set of 4 values, depending on the value of the 2-bits data to be coded. For example:
a first value of AS=5% may be used to encode a 2-bits data which value is 00,
a second value of AS=35% may be used to encode a 2-bits data which value is 01,
a third value of AS=65% may be used to encode a 2-bits data which value is 10,
a fourth value of AS=95% may be used to encode a 2-bits data which value is 11,
   As a consequence, a light spot which passes through an elementary data area is converted by a detector pixel into an electrical signal which may take 4 different levels. By the use of three thresholds (or N−1 thresholds generally speaking) applied to this electrical signal, the 2-bits data can easily be recovered.

The layer may be made of any material (e.g. aluminium, plastic . . . ) on which apertures or reflecting areas of variable surfaces are included.

FIG. 6C illustrates a third solution of a two-levels data coding in an elementary data area EDA (N=4 in this case). The elementary data area comprises a layer made of a polarized material whose polarization orientation (illustrated by the two-directional arrow) is characterized by an angle φ. The angle φ is taken among a set of 4 values, depending on the value of the 2-bits data to be coded. For example:
a first value of φ=0° may be used to encode a 2-bits data which value is 00,
a second value of φ=30° may be used to encode a 2-bits data which value is 01,
a third value of φ=60° may be used to encode a 2-bits data which value is 10,
a fourth value of φ+=90° may be used to encode a 2-bits data which value is 11,
   As a consequence, a light spot which passes through an elementary data area is converted by a detector pixel into an electrical signal which may take 4 different levels. By the use of three thresholds (or N−1 thresholds generally speaking) applied to this electrical signal, the 2-bits data can easily be recovered.

The light spots applied to the information carrier must be polarized according to a given and fixed direction.

The layer may be made of a polarized material corresponding to a liquid crystal (LC) element. The polarization direction may for example be varied by varying the thickness of this material.

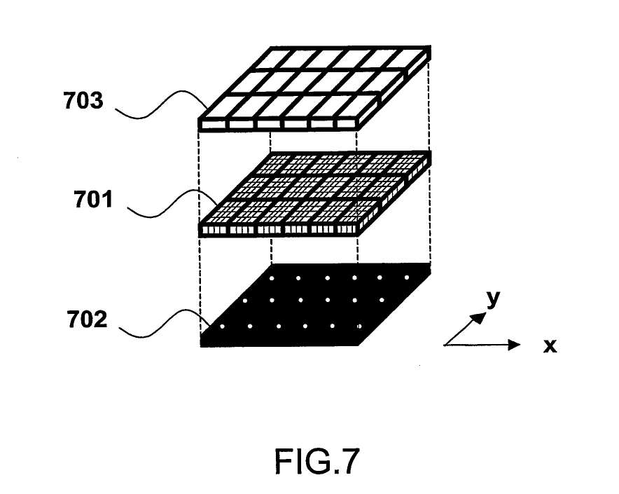

FIG. 7 depicts a three-dimensional view of the system as depicted in FIG. 2. It comprises an array of apertures 702 for generating an array of light spots applied to the information carrier 701. Each light spot is applied and scanned over a two-dimensional set of data of the information carrier 701 (represented by bold squares). In response to this light spot, the information carrier generates (or not, if the light spot is applied to a non-transparent area) an output light beam in response, which is detected by the pixel of the detector 703 opposite the set of data which is scanned. The scanning of the information carrier 701 is performed in displacing the array of apertures 702 along the x and y axes.

The array of apertures 702, the information carrier 701 and the detector 703 are stacked in parallel planes. The only moving part is the array of apertures 702.

It is noted that the three-dimensional view of the system as depicted in FIG. 1 would be the same as the one depicted in FIG. 7 in replacing the array of apertures 702 by the array of micro-lenses 102.

The scanning of the information carrier by the array of light spots is done in a plane parallel to the information carrier. A scanning device provides translational movement of the light spots in the two directions x and y for scanning all the surface of the information carrier.

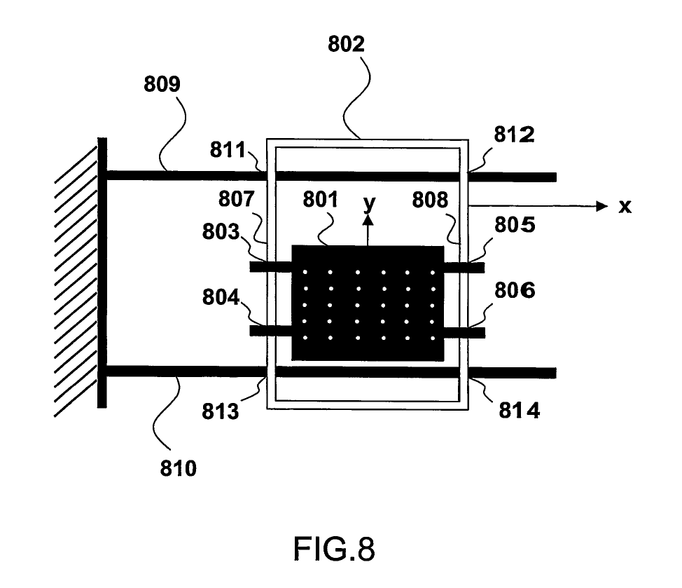

In a first solution depicted in FIG. 8, the scanning device corresponds to an H-bridge. The optical element generating the array of light spots (i.e. the array of micro-lenses or the array of apertures) is implemented in a first sledge 801 which is movable along the y axis compared to a second sledge 802. To this end, the first sledge 801 comprises joints 803-804-805-806 in contact with guides 807-808. The second sledge 802 is movable along the x axis by means of joints 811-812-813-814 in contact with guides 809-810. The sledges 801 and 802 are translated by means of actuators (not represented), such as by step-by-step motors, magnetic or piezoelectric actuators acting as jacks.

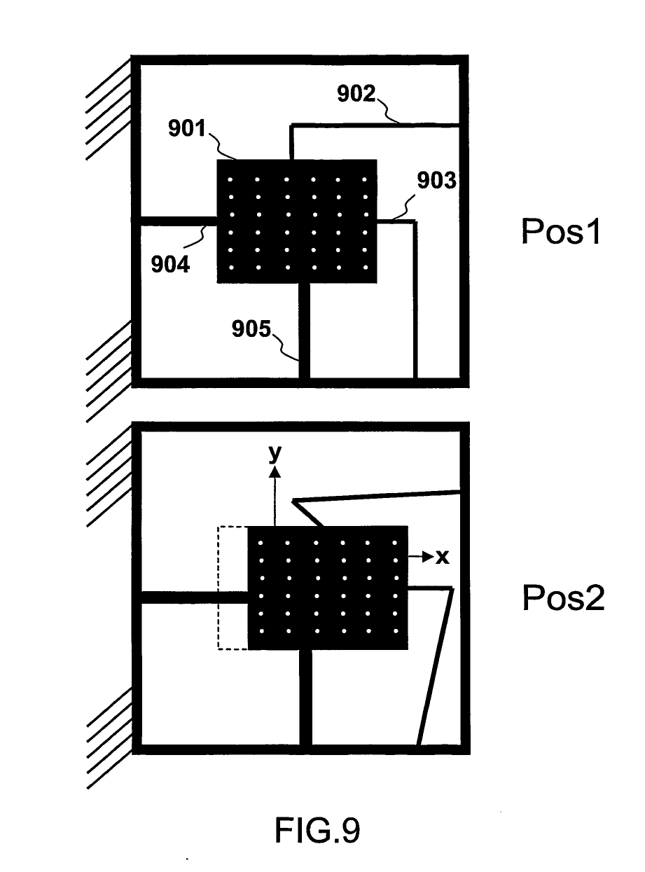

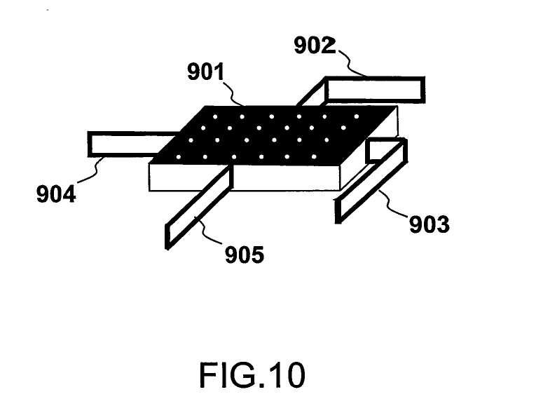

In a second solution depicted in FIG. 9, the scanning device is maintained in a frame 901. The elements used for suspending the frame 901 are depicted in a detailed three-dimensional view in FIG. 10. These elements comprise:
a first leaf spring 902,
a second leaf spring 903,
a first piezoelectric element 904 providing the actuation of the scanning device 901 along the x axis,
a second piezoelectric element 905 providing the actuation of the scanning device 901 along the y axis.

The second solution depicted in FIG. 9 has less mechanical transmissions than the H-bridge solution depicted in FIG. 8. The piezoelectric elements, in contact with the frame 901, are electrically controlled (not represented) so that a voltage variation results in a dimension change of the piezoelectric elements, leading to a displacement of the frame 901 along the x and/or the y axis.

The position Pos1 depicts the scanning device 901 in a first position, while the position Pos2 depicts the scanning device 901 in a second position after translation along the x axis. The flexibility of the leaf springs 902 and 903 is put in evidence.

A similar configuration can be built with four piezoelectric elements, the two extra piezoelectric elements replacing the leaf springs 902 and 903. In that case, opposite pair of piezoelectric elements act together in one direction in the same way as an antagonistic pair of muscles.

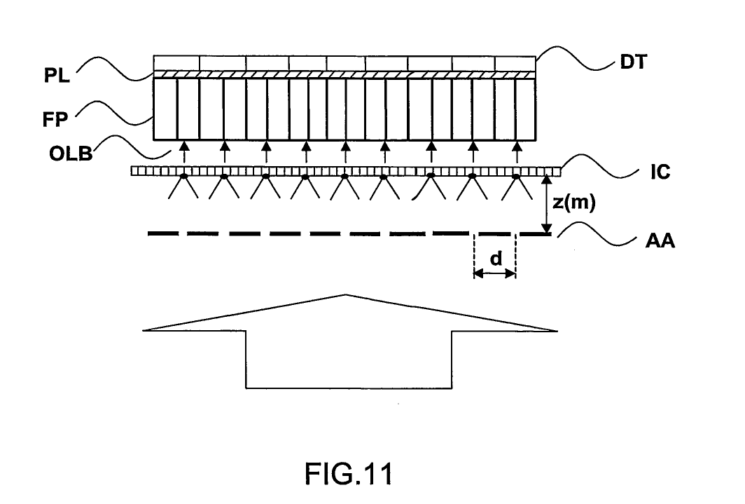

In a third embodiment depicted in FIG. 11, the system according to the invention comprises an optical fiber plate FP stacked on the detector DT for carrying the output light beams OLB generated at the output of the information carrier IC The output light beams OLB are derived from the array of light spots generated by the array of apertures AA and applied to the information carrier IC. The optical fiber plate FP is thus intended to be inserted between the information carrier and the detector.

The optical fiber plate FP consists of a multitude of cylindrical optical fiber elements bundled in parallel together in a glass plate (for example, but not necessarily, by using glue), and polished into an optical plate having two flat sides. A light distribution at one end of the plate is thus carried through the fibers to the other side of the plate without cross-talk. Typically, the pitch of the fibers is on the order of a few microns, the numerical aperture of the fibers is 1 and their transmission efficiency is for example in the range 70-80%.

The optical fiber plate FP is placed as close as possible to the detector DT for limiting cross-talk at the output of the fibers.

Advantageously, a protection layer PL (represented cross-hatched) is inserted between the optical fiber plate FP and the detector DT, for mechanically strengthening the detector and protecting the sensitive area of each pixel constituting the detector. Moreover, this allows the optical fiber plate FP, the protection layer PL and the detector DT to be fixed together for example by means of glue or pressed by a clamp system (not shown), defining as a consequence a single unit intended to be placed above the information carrier IC.

The optical fiber plate FP is characterized by its fiber density defined as the number of fibers per unit area. Basically, one fiber faces one pixel of the detector. Advantageously, a plurality of fibers face one pixel of the detector (as represented in FIG. 1), which avoid to define an accurate alignment between the fibers and the pixels of the detector.

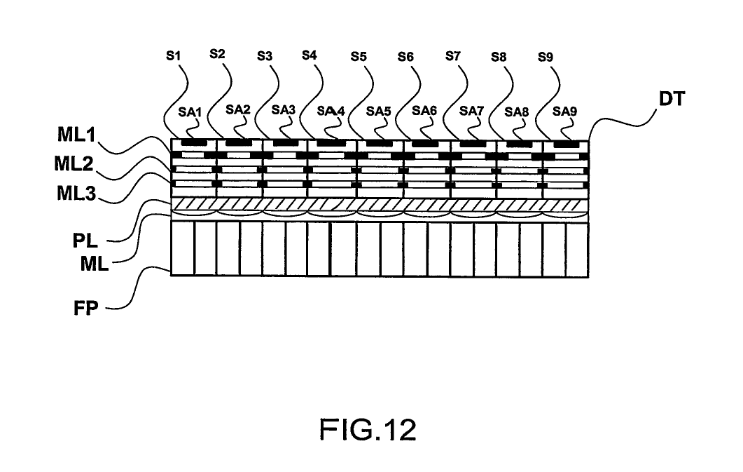

FIG. 12 depicts a detailed view of the third system according to the invention. In particular, it is depicted that the detector DT comprises:
a plurality of pixels S1-S9 (this number being given as an example), each pixel comprising a sensitive area SA1-SA9, respectively, for converting incident light into an electrical signal.
a first metallization layer ML1, a second metallization layer ML2 and a third metallization layer ML3 which are part of the standard CMOS design, and play here an additional role in reducing cross-talk.

The protection layer PL is stacked on the detector DT so that metallization layers are protected, which ensures a stable quality of detection in the long term. Since the protection layer and the detector can form a single unit, it can be considered that the optical fiber plate FP and the detector DT are stacked.

Advantageously, an array of micro-lenses ML is inserted between the optical fiber plate FP and the detector for converging the light beams generated at the output of the fibers towards the sensitive areas SA1-SA9 of each pixel. Each micro-lens faces one pixel of the detector. The cross-talk at the output of the optical fiber plate is thus reduced.

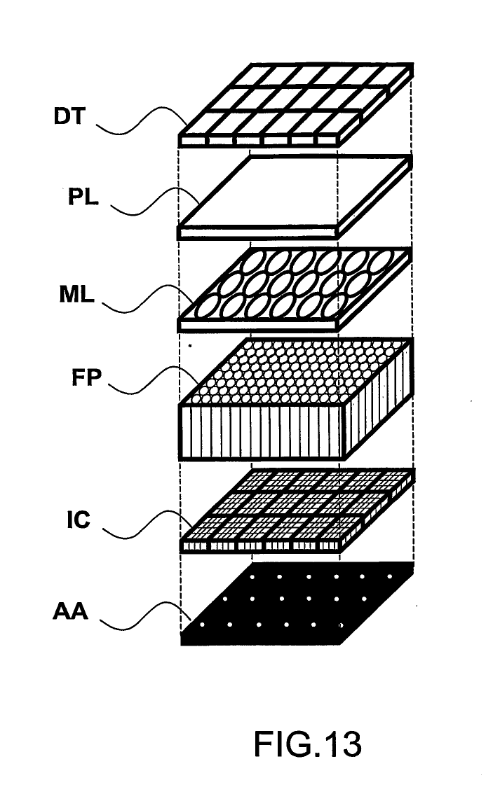

FIG. 13 depicts a three-dimensional view of the third system according to the invention.

Alternatively, in a preferred embodiment according to the invention, the elementary data areas of the information carrier no longer define square shapes, but hexagonal shapes. Compare to the use of square shapes, hexagonal shapes leads to significant advantages as discussed in the following.

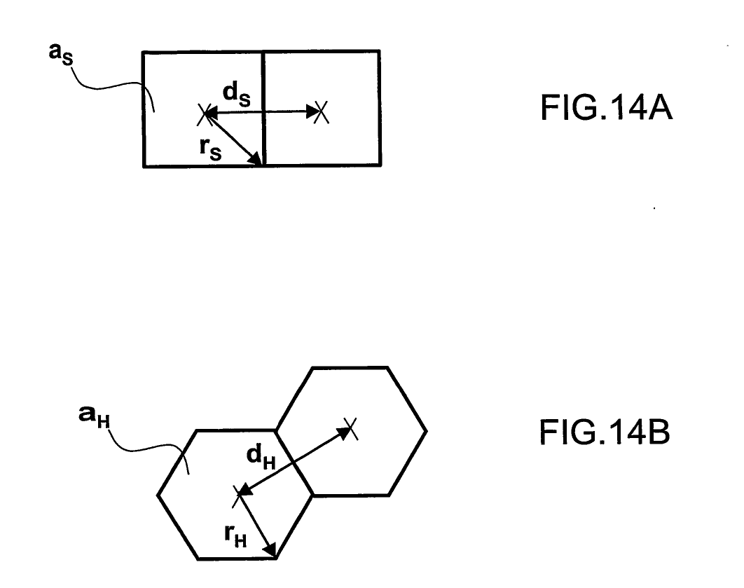

FIG. 14A depicts two adjacent elementary data areas having square shapes as described previously, while FIG. 14B depicts two adjacent elementary data areas having hexagonal shapes.

Concerning FIG. 14A, the surface as of each elementary data area, the distance d_{S} between the centres of two adjacent elementary data areas, and the maximum distance r_{S} separating the centre of an elementary data area and an adjacent elementary data, are expressed by the following relations:
a_{S}=2r_{S}² (1)
a_{S}=d_{S}² (2)
d_{S}=\sqrt{2}.r_{S} (3)

Concerning FIG. 14B, the surface a_{H} of each elementary data area, the distance d_{H} between the centres of two adjacent elementary data areas, and the maximum distance r_{H} separating the centre of an elementary data area and an adjacent elementary data, are expressed by the following relations:

$$\begin{matrix}{a}_{H} = \frac{3}{2} \sqrt{3} \cdot {r}_{H}^{2} & ( 4 ) \\ {a}_{H} = \frac{\sqrt{3}}{2} \cdot {d}_{h}^{2} & ( 5 ) \\ {d}_{H} = \sqrt{3} \cdot {r}_{H} & ( 6 )\end{matrix}$$

Storage capacity of the information carrier is eventually limited by the spot size. The minimum achievable spot size dictates the minimum required separation between the elementary data areas. If the separation is too small, there will be overlap of the spot on neighbouring bits (so-called cross talk or inter-symbol interference) and bit detection will be difficult. The storage capacity of the information carrier (either having square or hexagonal elementary data areas) is thus determined in calculating how many bits per square inch can be stored for a given bit separation. Having a given bit separation is expressed by the relation d_{H}=d_{S}. Which such a relation, the ratio a_{S}/a_{H} may be expressed from (5) and (2) by the following relation:

$$\frac{{a}_{S}}{{a}_{H}} = \frac{2}{\sqrt{3}} \approx 1.15 \qquad ( 7 )$$

This indicates that the data density of the information carrier (in bits per elementary data area) may be increased by 15% if an hexagonal lattice is used instead of a square lattice.

Advantageously, the elementary data areas may be arranged according to adjacent macro-cells also having hexagonal shape. If the area A_{H} of the hexagonal macro-cells is chosen so as to equal the area A_{S} of the square macro-cells, then the ratio D_{H}/D_{S} may be expressed by the following relation:

$$\frac{{D}_{H}}{{D}_{S}} = \sqrt{\frac{2}{\sqrt{3}}} \approx 1.07 \qquad ( 8 )$$

where D_{H} is the distance between the centres of two adjacent hexagonal macro-cells,
D_{S} is the distance between the centres of two adjacent square macro-cells.
   This means that for the same light spots density, the light spots separation, i.e. the distance between the centre of two adjacent macro-cells, is 7% larger when the macro-cells are hexagonal, making the bit detection more robust since crosstalk between adjacent elementary data area is reduced.

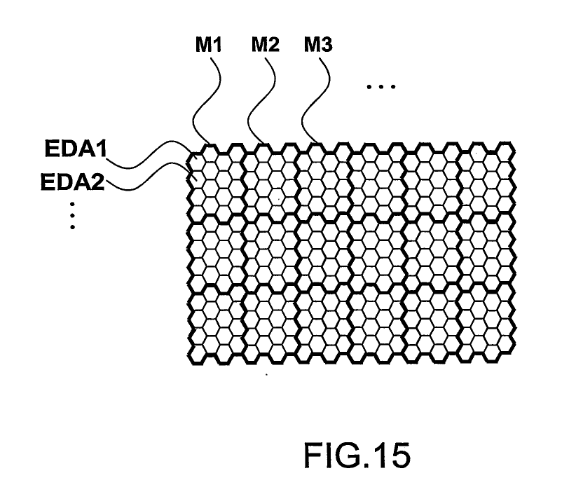

FIG. 15 represents a top view of an improved information carrier according to the invention comprising a plurality of adjacent macro-cells (M1, M2, M3, . . . ) each having a square shape, each macro-cell comprising a set of elementary data areas (EDA1, EDA2, . . . ) each having an hexagonal shape. In this example, each macro-cell comprises 16 elementary data areas. To facilitates the scanning of a macro-cell, the elementary data areas are advantageously placed adjacent.

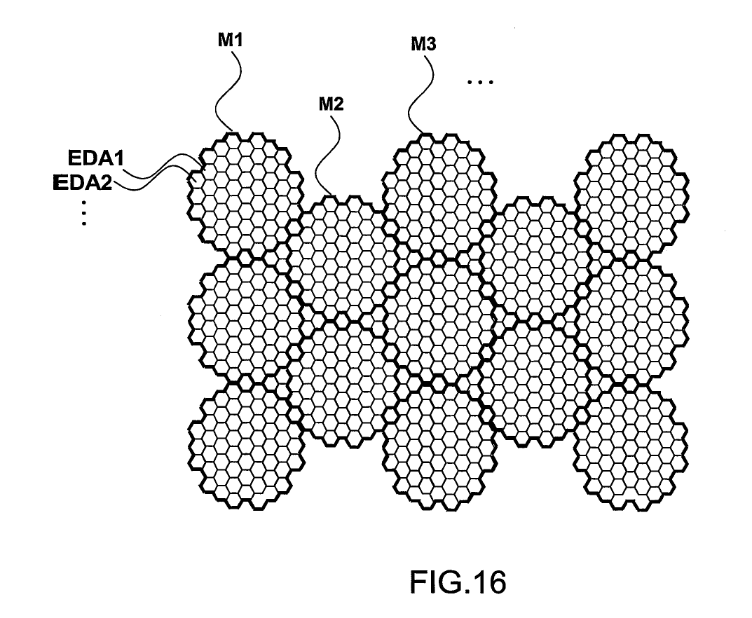

FIG. 16 represents a top view of an improved information carrier according to the invention comprising a plurality of adjacent macro-cells (M1, M2, M3, . . . ) each having an hexagonal shape, each macro-cell comprising a set of elementary data areas (EDA1, EDA2, . . . ) each having an hexagonal shape. In this example, each macro-cell comprises 55 elementary data areas. To facilitates the scanning of a macro-cell, the elementary data areas are advantageously placed adjacent.

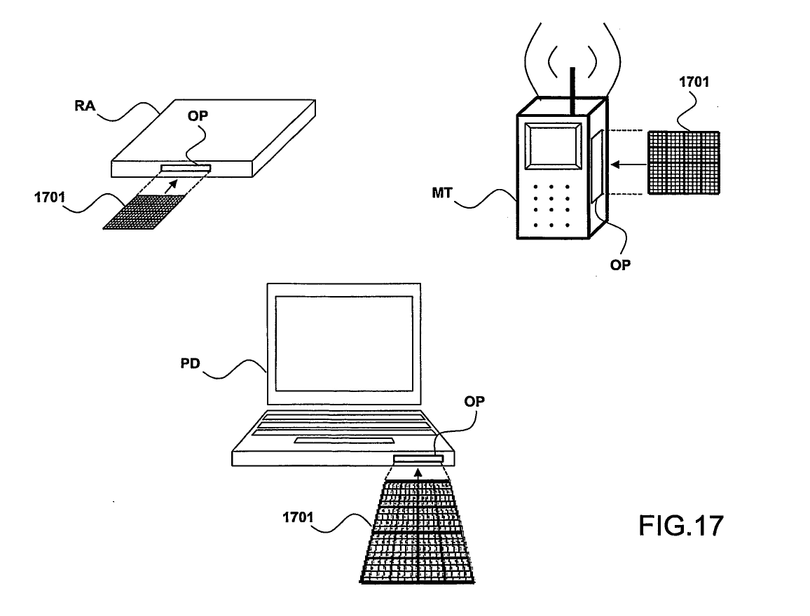

As illustrated in FIG. 17, the system according to the invention may advantageously be implemented in a reading apparatus RA (e.g. home player apparatus . . . ), a portable device PD (e.g. portable digital assistant, portable computer, a game player unit . . . ), or a mobile telephone MT. These apparatus and devices comprise an opening (OP) intended to receive an information carrier 1701 according to the invention, and a reading system in view of recovering data stored on said information carrier.

Use of the verb “comprise” and its conjugations does not exclude the presence of elements or steps other than those stated in the claims. Use of the article “a” or “an” preceding an element or step does not exclude the presence of a plurality of such elements or steps.

1. System for reading data stored on an information carrier (101-201), said system comprising:
an optical element (102-202) for generating an array of light spots (103-203) from an input light beam (104-204), said array of light spots (103-203) being intended to scan said information carrier (101-201),
a detector (105-205) for detecting said data from an array of output light beams generated by said information carrier (101-201) in response of said array of light spots (103-203).

2. System as claimed in claim 1, wherein the optical element (102-202) is an array of lenses (102) or an array of apertures (202).

3. System as claimed in claim 1, wherein the detector (105-205) comprises an array of pixels, each pixel being intended to detect a plurality of data stored on the information carrier (101-201).

4. System as claimed in claim 1, comprising an optical fiber plate (FP) stacked on said detector for carrying said output light beams.

5. System as claimed in claim 4, comprising an array of micro-lenses (ML) inserted between said optical fiber plate (FP) and said detector, each micro-lens facing a pixel of the detector.

6. System as claimed in claim 1, comprising means for shifting the optical element (102-202) over the information carrier (101-201).

7. Reading apparatus for reading data stored on an information carrier, said reading apparatus comprising a system as claimed in claim 1.

8. Information carrier comprising a plurality of adjacent macro-cells (M1, M2, M3 . . . ), each macro-cell comprising a set of elementary data areas (EDA1, EDA2 . . . ).

9. Information carrier as claimed in claim 8, wherein each of said elementary data areas (EDA1, EDA2 . . . ) is made of a layer intended to define at least two light-reflecting levels.

10. Information carrier as claimed in claim 8, wherein each of said elementary data areas (EDA1, EDA2 . . . ) is made of a layer intended to define at least two light-absorbing levels.

11. Information carrier as claimed in claim 10, wherein said layer is made of a material having a variable light-transmission coefficient for defining said levels.

12. Information carrier as claimed in claim 10, wherein said layer has a variable thickness for defining said levels.

13. Information carrier as claimed in claim 10, wherein said layer comprises an aperture of variable surface for defining said levels.

14. Information carrier as claimed in claim 10, wherein said layer is made of a light-polarized material whose polarization orientation is variable for defining said levels.

15. Information carrier as claimed in claim 9, wherein said layer comprises a reflecting area of variable surface for defining said levels.

16. Information carrier as claimed in claim 8, wherein said macro-cells (M1, M2, M3 . . . ) have a square shape.

17. Information carrier as claimed in claim 8, wherein said macro-cells (M1, M2, M3 . . . ) have an hexagonal shape.

18. Information carrier as claimed in claim 17, wherein said elementary data areas (EDA1, EDA2 . . . ) have a square shape or an hexagonal shape.

19. A portable device comprising a system as claimed in claim 1.

20. A mobile telephone comprising a system as claimed in claim 1.

21. A game player unit comprising a system as claimed in claim 1.
